(19) United States
(12) Patent Application Publication
(10) Pub. No.: US 2002/0094185 A1
(43) Pub. Date: Jul. 18, 2002

(54) Holding a component on an optical micro bench

(76) Inventors: Ian Hopkin, Liskeard (GB); Robert Musk, Kingsbridge (GB)

Correspondence Address: LACASSE & ASSOCIATES, LLC, 1725 DUKE STREET, SUITE 650, ALEXANDRIA, VA, 22314, US

(21) Appl. No.: 09/733,981

(22) Filed: Dec. 12, 2000

(51) Int. Cl. G02B 6/00; B25B 1/00

(52) U.S. Cl. 385/137; 269/254 R

(57) ABSTRACT

A device for holding a component of a fiber optic circuit on a substrate includes two resilient arms or two series of spring fingers, one on each side of the component. Ideally, the substrate is crystalline silicon and the arms or fingers are fabricated using a DRIE etching process. The holding device is particularly suited for securing an optical fiber in a groove, but it can also be used for fixing other components, i.e. lenses.

### FIELD OF INVENTION

The present invention relates to a device for holding a component on a substrate, and in particular to a device for holding an optical component, such as an optical fiber, in a groove etched in a crystalline silicon substrate.

### BACKGROUND OF THE INVENTION

Recent demands in the fiber optics industry to increase durability and decrease cost have led to the use of micro-electromechanical systems (MEMS) in key optical components. However, problems arise when other components are to be connected to the substrate. In particular, the positioning of optical fibers and lenses on the substrate has led to a variety of problems.

In the past these other components have been fixed to the substrate using epoxy resins. For example. U.S. Pat. No. 5.937,132 issued Aug. 10, 1999 in the name of Pierre Labeye et al discloses a process and a system for positioning and holding optical fibers in a groove using an adhesive material introduced therein. Unfortunately, there are several applications in which the use of epoxy resins is not acceptable, e.g. in 980 nm pump laser sources for fiber amplifiers, the use of organic materials such as epoxy resins is undesirable because of the damage to the laser facet.

Another method of fixing components to a substrate is to solder or weld a separate holder overtop of the fiber. U.S. Pat. Nos. 5,717,803, issued Feb. 10, 1998 in the name of Isao Yoneda et al, and 5,367,140, issued Nov. 22, 1994 to Musa Jouaneh et al disclose coupling methods utilizing a separate holder requiring welding or soldering to the substrate.

U.S. Pat. No 4,788,406, issued Nov. 29, 1988 to Robert Holman et al, is indicative of another approach used to attach an optical fiber to a substrate. In this approach, a metallic sleeve is coated or mounted on the end of the fiber, so that the sleeve can be welded to a plate of similar material mounted on the substrate.

So far, the use of soldering or welding techniques to fix optical components to a substrate is quite labor intensive, requiring several additional steps to modify the elements, whereby they can be connected.

U.S. Pat. No. 5,961,849, issued Oct. 5, 1999 to Robert Bostock et al, discloses another mounting method, in which a MEMS device is used to hold down an optical fiber in a groove. This device is also relatively complicated to manufacture, requiring the deposition of a special layer onto the substrate. Moreover, many MEMS devices require power to operate.

It is an object of the present invention to avoid the shortcomings of the prior art by providing a relatively simple mounting device to hold an optical component on a substrate without the need for adhesives, solder or welds, and without the need for power consumption.

Accordingly, the present invention relates to a device for holding a component on an substrate comprising first and second opposed resilient arm means extending from the substrate for holding the component therebetween.

### BRIEF DESCRIPTION OF THE DRAWINGS

The invention will be described in greater detail with reference to the accompanying drawings, which illustrate preferred embodiments of the invention, wherein:

FIG. 1 is a top view of a component holding device according to the present invention;

FIG. 2 is a cross-sectional view of the device of FIG. 1 taken along line A-A;

FIG. 3 is a cross-sectional view of the device of FIG. 1 illustrating the spring fingers experiencing twist;

FIG. 4 is a top view of a second embodiment of the component holding device according to the present invention;

FIG. 5 is a cross-sectional view of the device of FIG. 4 taken along line B-B;

FIGS. 6 to 11 are side views of the substrates used in the present invention at various stages during the manufacturing thereof-,

FIG. 12 is an end view of a third embodiment of the component holding device according to the present invention;

FIG. 13 is an end view of the device of FIG. 12 with an optical fiber in place;

FIG. 14 is a top view of the device of FIGS. 12 and 13;

FIG. 15 is an end view of a fourth embodiment of the component holding device according to the present invention;

FIG. 16 is an end view of the device of FIG. 14 with a lens in place;

FIGS. 17 to 21 illustrate a series of steps using another embodiment of the invention to lock an optical fiber on a substrate;

FIGS. 22 to 25 illustrate additional steps taken to interlock the present invention with the component; and

FIGS. 26 to 28 illustrate a further embodiment of the present invention in which the component is mounted in a housing.

### DETAILED DESCRIPTION

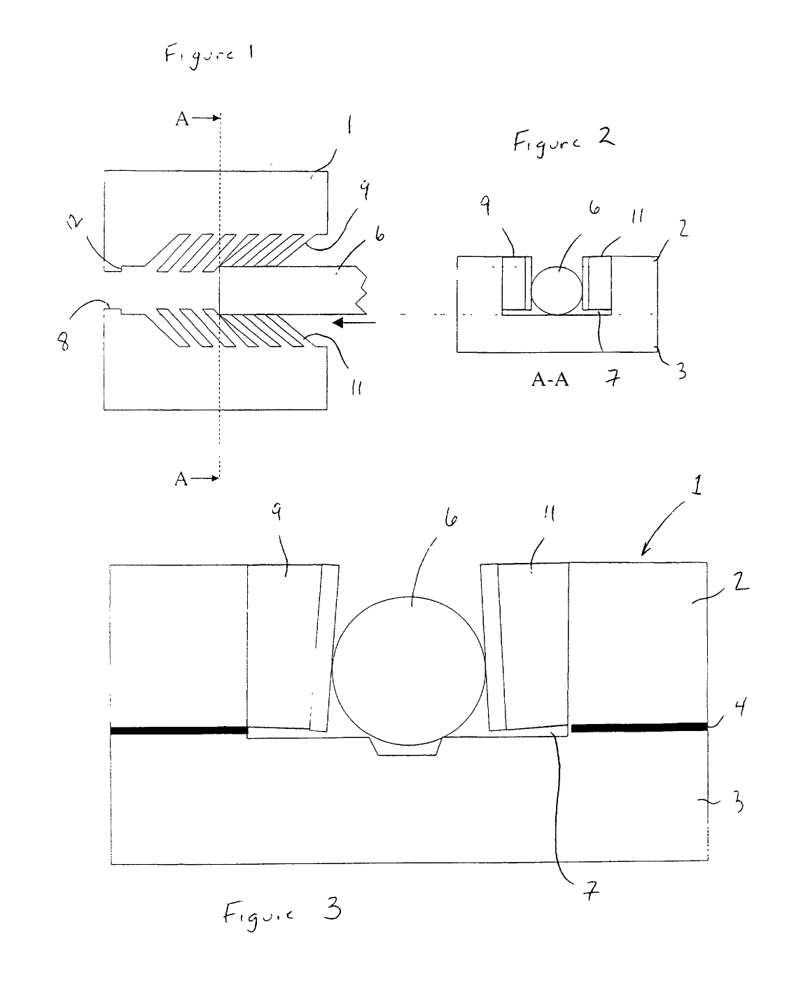

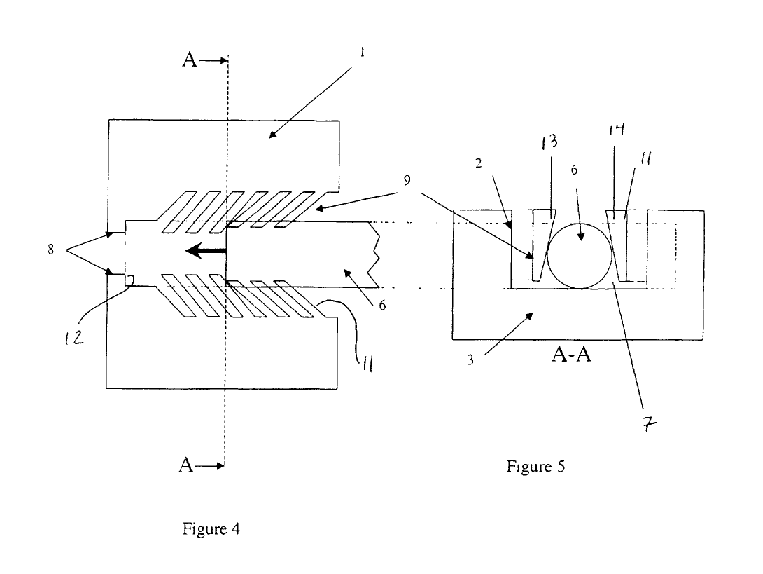

With reference to FIGS. 1 to 5, the device of the present invention is formed in a substrate 1, typically crystalline silicon, comprised of an upper wafer 2 and a lower wafer 3 with a silicon dioxide layer 4 therebetween. The device holds an optical fiber 6 in a rectangular groove 7 in alignment with an opening 8. The opening 8 allows the fiber 6 to be optically coupled with another component, e.g. a laser alignment platform (not shown). The holding device includes a first series of elongated rectangular spring fingers 9 extending outwardly and laterally from one side of the groove 7, and a second series of elongated rectangular spring fingers 1I1 extending outwardly and laterally from the other side of the groove 7. The second series of spring fingers 1I1 are generally opposed to the first series of spring fingers 9, each series of fingers applying an equal and opposite lateral force onto the fiber 6 to prevent lateral movement thereof. In the preferred arrangement, illustrated in FIGS. 1 to 5, the first and second series of spring fingers 9 and 11 extend outwardly in opposite directions and laterally in the same general direction, towards the end of the groove with the opening 8. Typically, the spring fingers extend from the walls of the groove at approximately a 60° angle, although any angle is possible as long as the resulting force of the spring fingers is sufficient to hold the fiber in place. This arrangement makes withdrawal of the fiber 6 much more difficult than insertion. In practice, the fiber 6 is inserted between the two sets of spring fingers 9 and 11, which causes them to deform (FIGS. 1 and 4), until the end of the fiber 6 abuts a shoulder 12 of the opening 8, thereby locking the fiber 6 in place.

To increase the downward force on the optical fiber the spring fingers 9 and 11 are adapted to contact the fiber 6 above the horizontal central axis thereof. In the aforementioned basic arrangement, the spring fingers 9 and 11 twist slightly about their longitudinal axis, due to the fact that they contact the fiber below their midline (See FIG. 3). This twisting raises the point of contact of the finger on the fiber, thereby providing the downward force. Alternatively, having an upper portion of the spring fingers 9 and 11 sloped inwardly towards each other, also accomplishes this objective. As best seen in FIG. 5, the entire inner surfaces 13 and 14 of the spring fingers 9 and 11, respectively, can be sloped inwardly, resulting in wedge-shaped fingers.

The number of springs and their dimensions is a function of the overall package requirement and is determined from fiber insertion and location force requirements. If we assume that each spring finger has a width b and a length L, and that the upper wafer has a thickness t, we can calculate the spring constant K from:

$$K = \frac{3 \times E \times I}{{L}^{3}}$$

$$where I = \frac{{b}^{3} t}{12} and E is Young ' s Modulus$$

Deep reactive ion etch (DRIE) processes, such as those offered by Surface Technology Systems Ltd., are highly anisotropic and capable of machining mechanical structures within silicon which cannot be realized with wet etch techniques. In particular, the ability to produce features with vertical side walls, enables low stress micro-mechanical systems to be manufactured. Accordingly, if the DRIE process is already being used on the substrate in the fabrication process, the component holding device according to the present invention can be machined at the same time using this process by adding the features to the appropriate etch mask.

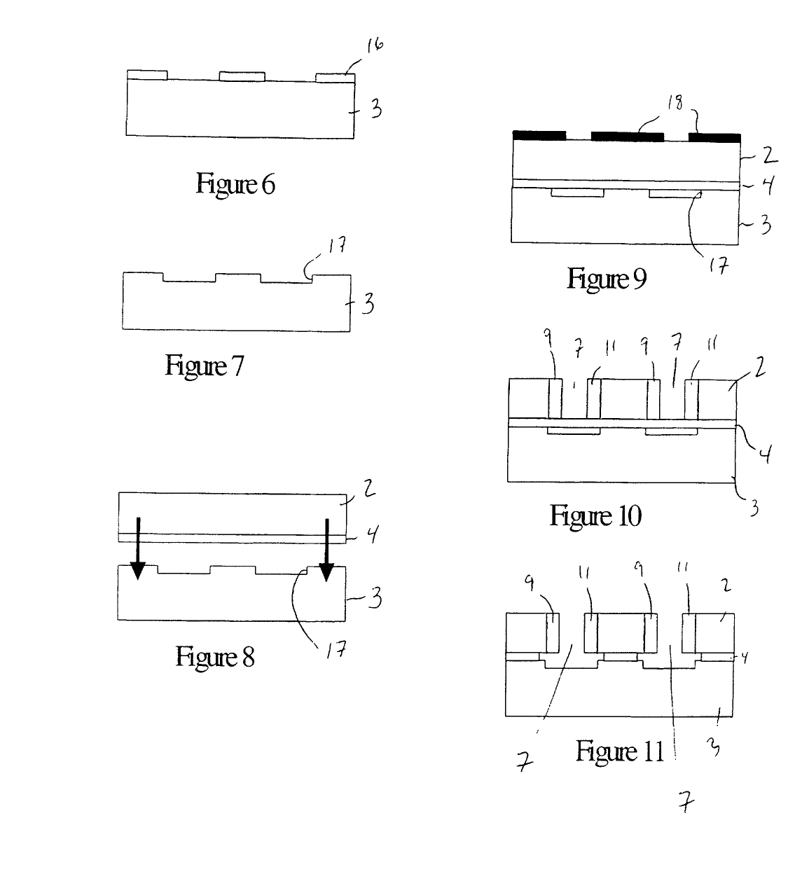

A silicon-on-insulator (SOI) structure or a silicon wafer annodically bonded to glass are two of the possibilities for manufacturing the device so that the springs are suspended above the bottom of the groove. The use of the SO1 is often preferable because of the superior thermal conductivity properties of silicon relative to glass. FIGS. 6 to 11 illustrate an example of a series of steps using an SOI structure in the manufacture of the embodiment of the present invention illustrated in FIGS. 1 to 5.

Initially, a masking layer 16 is applied to the upper surface of lower silicon wafer 3 (FIG. 6), and shallow channels 17 are etched therefrom (FIG. 7). Subsequently, upper wafer 2, with intermediate oxidized layer 4, is fusion bonded on top of lower wafer 3 (FIG. 8). An appropriate mask 18 is applied to the top layer of upper wafer 2 (FIG. 9), and grooves 7 with spring fingers 9 and 11 are etched out down to intermediate layer 4 (FIG. 10). Lastly, an appropriate amount of the intermediate layer 4 is removed, freeing the spring fingers 9 and 11 (FIG. 11).

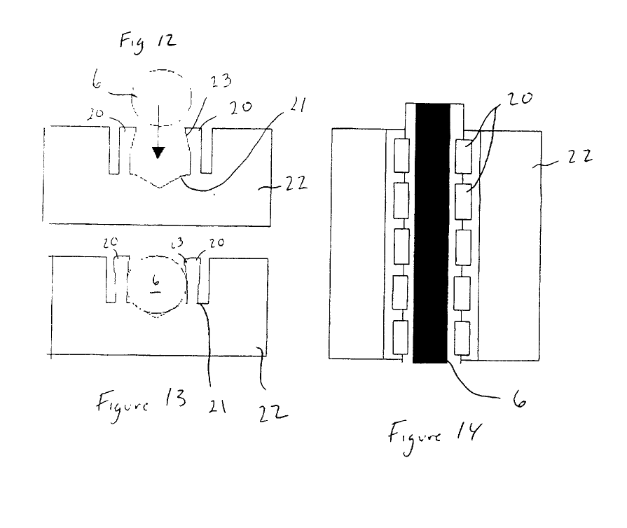

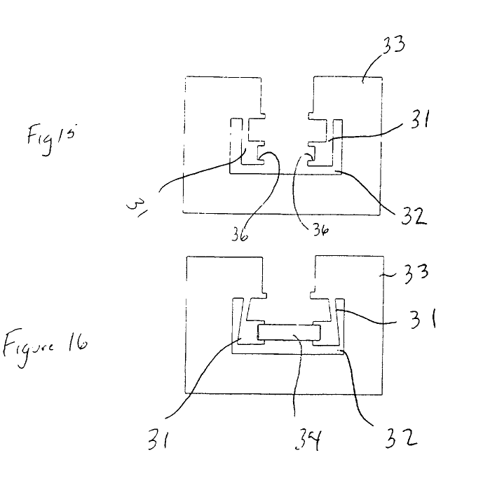

FIGS. 12 to 14 illustrate another embodiment of the present invention, in which spring fingers 20 extend upwardly from the bottom of a groove 21, formed in silicon wafer 22. Preferably, the inner wall 23 of the upper end of each spring finger 20 is angled inwardly, thereby applying a downward force on the fiber 6 and/or restricting upward movement of the fiber 6.

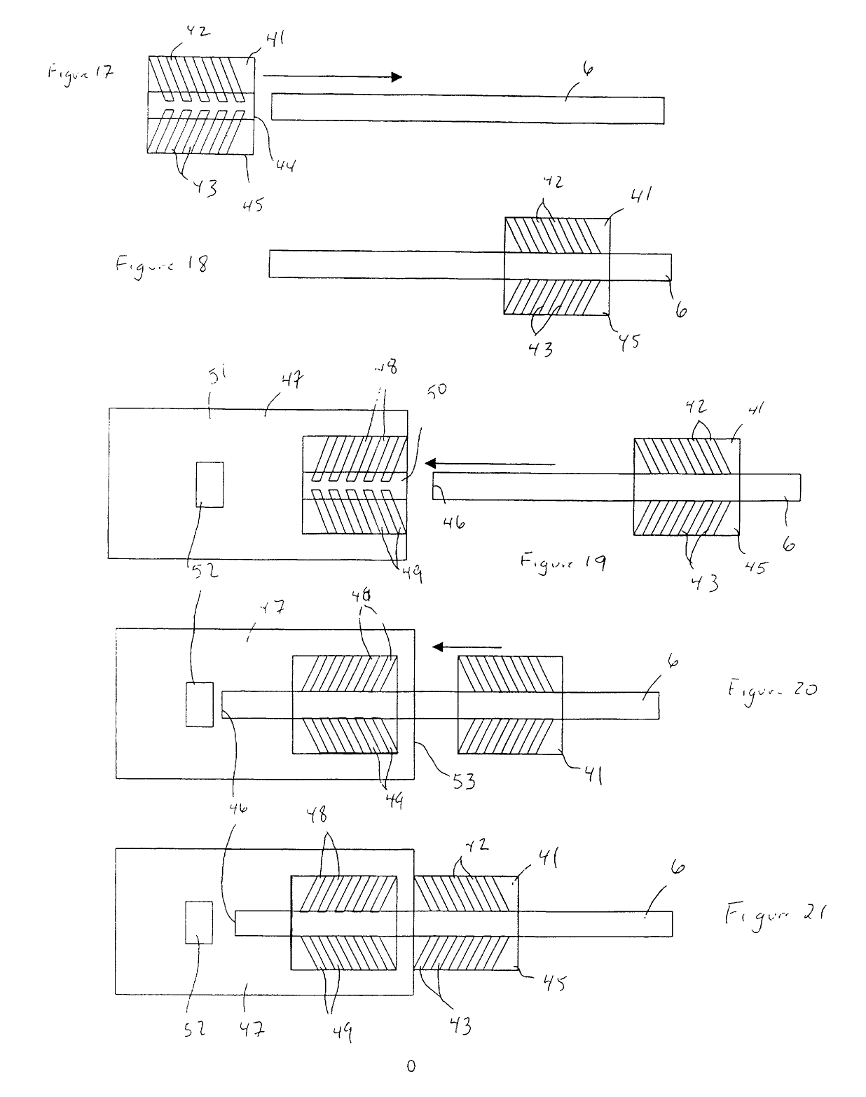

FIGS. 15 and 16 illustrate a third embodiment of the present invention, in which L-shaped spring arms 31 extend downwardly into groove 32, etched into substrate 33. In FIG. 15, the spring arms 31 are in a relaxed position. In FIG. 16, the spring arms 31 are slightly bent and a lens 34 is held therebetween, suspended in the groove 32 by the opposed spring forces of the spring arms 31. The lens 34 is mounted in a trench 36, formed in each spring arm 31, to prevent any vertical movement thereof. Ideally, the groove 32 is made wide enough to enable the spring arm 31 to be spread apart wide enough to receive the lens 34. Alternatively, the sides of the trench 36 are resilient enough to allow the lens 34 to be mounted therein.

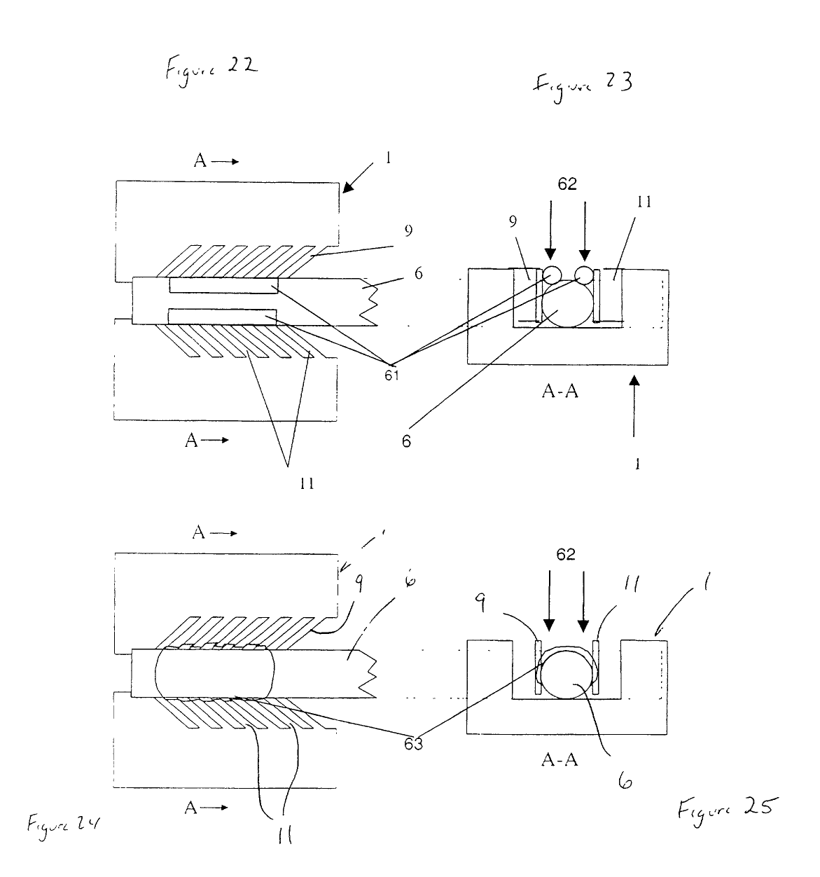

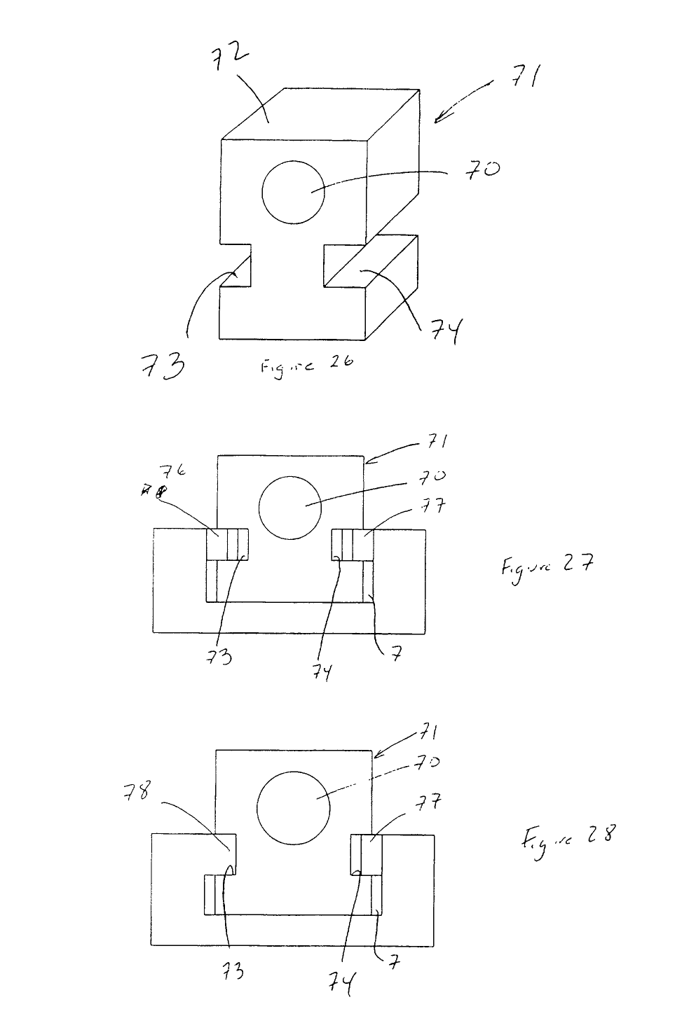

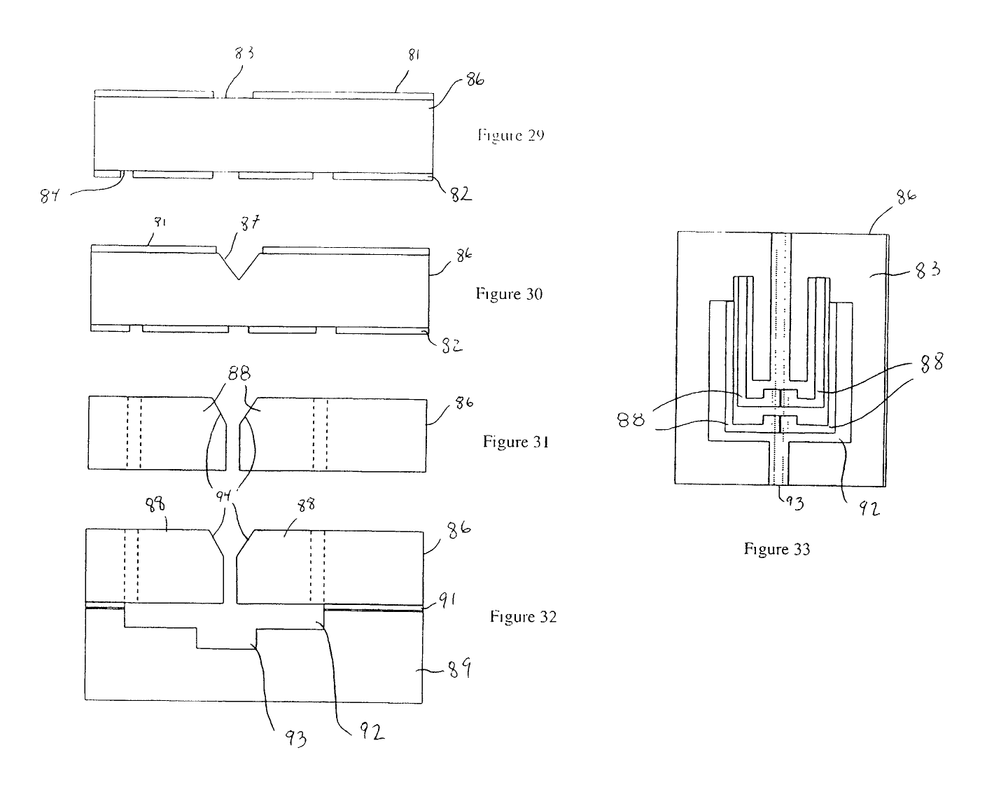

In certain applications, the substrate is not provided with a shoulder 12 to halt the insertion of fiber 6. FIGS. 17 to 21 illustrate an alternative means to prevent insertion and/or withdrawal of the fiber 6. Initially, a locking cleat 41 is mounted on an optical fiber 6 at a distance down the fiber 6 greater than the distance that the fiber 6 is to be inserted. The locking cleat 41 includes a first series of spring fingers 42 and a second series of spring fingers 43 extending into a groove 44, formed in a silicon substrate 45. A special MEMS tool (not shown) is used to open the spring fingers 42 and 43 so that the locking cleat 41 can be slid onto the fiber 6 in a direction opposite to the normal insertion direction. In this position the locking cleat 41 is prevented from sliding any further down the fiber 6, but is able to slide back towards the end 46 of the fiber. With reference to FIGS. 19 to 21, the fiber 6 is inserted into a normal holding device 47, which includes spring fingers 48 and 49 extending into a groove 50 formed in a substrate 51, until the end of the fiber 46 is correctly positioned proximate component 52. At which time, the locking cleat 41 is slid back towards the end of the fiber 46 until abutting an edge 53 of the substrate 51. In this position (FIG. 21) the fiber 6 is locked in both axial directions, unable to be inserted because of spring fingers 42 and 43, unable to be withdrawn because of spring fingers 48 and 49.

With reference to FIGS. 22 to 25, additional steps can be made to more securely interlock the spring fingers 9 and 11 to the component, which in the illustrated example is optical fiber 6. Initially, one or more glass pre-forms 61, made of low melting-point glass material, are positioned in the gaps between the upper portion of the spring fingers 9 or 11 and the upper portion of the component 6. The pre-forms 61 can be in any suitable form, including rods, balls or powder. In the second step, the pre-forms 61 are melted, causing the material to flow around the fiber 6 and in between the spring fingers 9 and 11. A CO₂ laser, generally indicated by arrows 62, is preferably used to melt the pre-forms 61, creating melt zones 63 (FIG. 25). The resulting melt zones 63 increase the contacting surface area between the fiber 6 and the fingers 9 and 11, providing added stability therebetween. In most cases it is preferable to form the pre-forms 61 out of glass, which has a melting point below that of the fiber 6 and the substrate 1, so that when the pre-forms 61 are melted neither the fiber 6 nor the substrate 1 undergo any localized melting. Moreover, it is preferable that the selected glass wets to the substrate to form a bond therebetween. A suitable coating can be added to the fiber and substrate to facilitate this bonding.

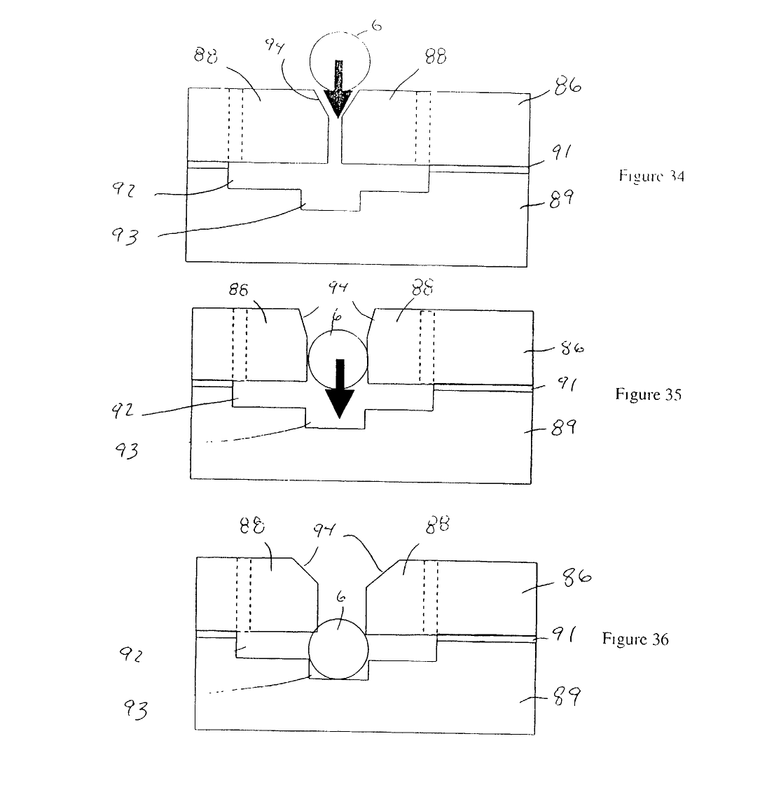

When the optical component 70 (FIG. 26) is too small, too fragile or has an incompatible shape, a housing 71 is provided for mounting the component 70 therein. In its simplest form, the housing 71 has a rectangular body 72 with first and second rectangular channels 73 and 74 formed in opposite sides thereof. The channels 73 and 74 are adapted to be engaged by the first and second spring fingers 76 and 77, respectively, for holding the housing 71 in the groove 7. Alternatively, one side of the groove 7 can be formed with a projection 78 for engaging the first channel 73, while one of the spring fingers 77 engages the second channel 74 (see FIG. 28). With reference to FIG. 29, spring finger 77 can be in any one of a variety of forms including a baffle spring 79. If the housing 71 is mounted in a recess in the substrate instead of a groove, the channels 73 and 74 can be formed in any of the sides of the housing 71. Similarly, the spring fingers 76 and 77, and/or the projection 78 would then be formed accordingly. The projection 78 can also take any one of a variety of forms other than the illustrated form, including a plurality of fingers.

We claim:

1. A device for holding a component on a substrate comprising first and second opposed resilient arm means extending from the substrate for holding the component therebetween.

2. The device according to claim 1, wherein said first resilient arm means and said second resilient arm means extend contiguously from opposite sides of a groove in the substrate.

3. The device according to claim 1, further comprising housing means, securing the component therein, which is adapted to be engaged by said first and second resilient arm means.

4. The device according to claim 3, wherein said housing means includes channel means in opposite sides thereof, adapted to receive said first and second resilient arm means therein.

5. The device according to claim 1, wherein the first resilient arm means comprises a plurality of first spring fingers extending from one side of a groove in the substrate; and wherein the second resilient arm means comprises a plurality of second spring fingers extending from an opposite side of the groove in the substrate, for holding an elongated component in the groove.

6. The device according to claim 5, wherein at least one of the first spring fingers contacts the component above a horizontal central axis thereof.

7. The device according to claim 5, wherein an upper portion of the first spring fingers extends inwardly, further than a lower portion thereof, into contact with the component, whereby a downward force is applied to the component for holding the component in the groove.

8. The device according to claim 1, wherein the first and second resilient arm means extend upwardly from proximate a bottom of a groove in the substrate.

9. The device according to claim 8, wherein the first and second resilient arm means extend upwardly and inwardly from proximate the bottom of the groove in the substrate.

10. The device according to claim 8, wherein a surface of the first resilient arm means which contacts the component is at an angle relative thereto, whereby a downward force is applied to the component for holding the component in the groove.

11. The device according to claim 8, wherein the first and second resilient arm means each comprise a plurality of spring fingers.

12. The device according to claim 1, wherein the outer free ends of the first and second resilient arm means are adapted to hold the component suspended over the substrate.

13. A device for holding a component on a substrate comprising:
housing means for supporting the component, said housing means having engaging means on two sides thereof;
projection means extending from the substrate for engaging one of said engaging means; and
spring arm means extending from the substrate for engaging the other of said engaging means.

14. The device according to claim 13, wherein said housing means includes channel means in each side thereof adapted to receive said spring arm means.

15. The device according to claim 13, wherein said spring arm means is contiguous with a side of a groove etched in the substrate.

16. A device for locking an elongated component on a substrate comprising:
locking cleat means mounted on said elongated component, preventing the elongated element from relatively moving in a first direction;
holding means on said substrate for receiving said elongated component, preventing the elongated component from relatively moving in a second direction, opposite the first direction; and
abutment means on said substrate for engaging said locking cleat means;
whereby when said locking cleat means engages said abutment means, the locking cleat means prevents movement of the elongated component in the first direction, and the holding means prevents movement of the elongated component in the second direction.

17. The device according to claim 16, wherein the locking cleat means is slideable on the elongate component in the first direction into engagement with said abutment means.

18. The device according to claim 17, wherein the locking cleat means comprises a substrate; a groove in said substrate; a first series of spring fingers extending into said groove into engagement with one side of said elongated component; and a second series of spring fingers extending into said groove into engagement with another side of said elongated component.

19. A method of securing a component on a substrate comprising the steps of:
positioning the component between a plurality of first spring fingers extending from one side of a groove in the substrate and a plurality of second spring fingers extending from an opposite side of the groove in the substrate;
positioning a solid pre-form material in a gap between the component and the spring fingers; and
melting the pre-form material, whereby the melted pre-form material flows over the component and in between the spring fingers, forming an interlocking structure therebetween.

20. The method according to claim 19, wherein the pre-form material is glass having a melting point below that of the component and the substrate.
